(19) United States
(12) Patent Application Publication
(10) Pub. No.: US 2019/0172121 A1
(43) Pub. Date: Jun. 6, 2019

(54) Method and System for Managing Online Bartering Exchange

(71) Applicant: Ishmael Fleming, Killeen, TX (US)

(72) Inventor: Ishmael Fleming, Killeen, TX (US)

(21) Appl. No.: 16/212,358

(22) Filed: Dec. 6, 2018

Related U.S. Application Data
(60) Provisional application No. 62/595,263, filed on Dec. 6, 2017.

(51) Int. Cl. G06Q 30/06; G06Q 30/02

(52) U.S. Cl. CPC G06Q 30/0633; G06Q 30/0253

(57) ABSTRACT

An online bartering exchange provides a plurality of user accounts a method and system to barter inventory list of items for wants list of items with each other. The method allows each user account to build the lists and specify characteristics of each item of the lists. The method compares the wants list of items for an arbitrary user account with the inventory list of items for each user accounts for potential matches. When a match is found, the method notifies the arbitrary account and the matching account for the match and manages the terms-and-conditions for the bartering exchange. The arbitrary account and the matching account then complete the exchange by a face-to-face meeting or mailing/shipping method. Then, the method manages the post-exchange review and rating process for each user account. Further, the method provides each user account an online method to create communal sale advertisements to cash out the user's inventory list of items. The method allows the user to move unsold items to an inventory list of items that are available for trade with other user accounts and sold inventory items to wants list of items for further bartering exchanges so that more similar or same items may be obtained later to be sold in future to increase sales.

The current application claims a priority to the U.S. Provisional Patent application Ser. No. 62/595,263 filed on Dec. 6, 2017.

### FIELD OF THE INVENTION

The present invention relates generally to a method and system for performing commerce. More specifically, the present invention relates to a method and system for managing an online bartering exchange.

### BACKGROUND OF THE INVENTION

Often, individuals organize garage sales to sell items directly to other people. Generally, such events last for only a few hours. Further, a limited number of prospective buyers may visit such events. Therefore, all the items on sale may not be sold and some items may be left over as inventory. The seller may try to trade the leftover inventory items on online platforms for items that can be later easily sold at a future garage sale. However, most existing online platforms only allow for goods or services to be bought in lieu of some form of currency. Many individuals and corporations may wish to exchange their items with items from other people and/or organizations. Therefore, online bartering exchange systems have come into service.

A bartering exchange system is an old method of exchange, which has been used for centuries and long before money was invented. In a bartering exchange system, individuals and organizations exchange services and goods for other services and goods in return. Today, bartering has made a comeback using techniques that are more sophisticated to aid in trading than ever before; for instance, the Internet. In ancient times, this system involved people in the same area, however today bartering is global. The value of bartering items can be negotiated with the other party. Bartering does not involve money which is one of the advantages. Individuals and organizations can acquire items by exchanging an item they have but no longer want or need. Generally, trading in this manner is done through online auctions and swap markets without the use of any fiat currency or cryptocurrency.

However, existing bartering exchange systems involve problems and difficulties. The most prominent problem is the lack of double coincidence of wants. The wants of the two parties who desire to exchange goods or services must coincide. For example, if party A wants to acquire smartphones in exchange for chairs, then he must find another party who wants chairs for smartphones. Such a double coincidence of wants involves great difficulty and time in a modern society, it rarely occurs. In the absence of a double coincidence of wants, the individuals under a bartering exchange system are compelled either to hold inventory items for long periods of time, or to make numerous intermediary exchanges in order to finally get the items of their preference.

The second problem is the absence of common measure of value. Even if it is possible to have the double coincidence of wants, the absence of a common measure of value creates great problem because it is very time-consuming to strike a bargain. Since there is no common measure in terms of which the value of an item can be expressed, the problem arises how many chairs should be exchanged for how many smartphones. In fact, under the bartering exchange system, every item must be expressed in terms of every other item. If, for example, there are 1000 items in the system, then, in the absence of monetary unit, every item can be exchanged for the remaining 999 items. What is true for one item will be true for all other 999 items.

Another problem is lack of divisibility, which relates to the fact that all items cannot be divided and subdivided. In the absence of a common medium of exchange, a problem arises, when a big indivisible item is to be exchanged for a smaller item. For example, if the price of a television is equal to 10 chairs, then a person having one chair cannot exchange it for the television because it is not possible to divide the television in small pieces without destroying its utility.

Further, under a bartering exchange system, there is absence of a proper and convenient means of storing wealth or value. As opposed to storing of generalized purchasing power in the form of money, the individuals have to store specific purchasing power in the form of smartphones, chairs, jackets, shoes, wheat, etc., under the bartering exchange system which may decrease in value over time due to aging and damages or a change in tastes and fashion. It is very expensive to keep specific goods or items in inventory for a long time.

Many existing online bartering exchange systems provide bartering services to their members and users. A user joins an exchange for a fee and pays a transaction fee every time the user conducts an exchange. The user earns either barter credits or barter dollars for items traded and/or services rendered. However, the user cannot use these barter credits or barter dollars outside the exchange but can use them on a cashless basis for purchases with other users on the same exchange. Further, the existing bartering exchange systems can complete the entire transactions online, such that the buyer and the seller never have to meet each other in person. This includes negotiating online, making the payment online and then shipping the items. This process enables the users to conduct exchanges with minimal engagement with each other. However, the process may lead to lack of actual contact between people, growth of disconnected societies and even loneliness.

Additionally, most existing online bartering exchange platforms either only allow for bartering exchange of goods and services, or only allow advertisement of goods and services available, or only allow advertising of garage sales, yard sales, moving sales, estate sales, community sales, multifamily sales, neighborhood sales etc., but not any combination of these. Further, before the present invention, there was no online platform that has combined all 3 of these platforms.

Therefore, there is a need for improved methods and systems that allow a bartering exchange of items and overcome the aforementioned problems and/or limitations. The present invention provides an online bartering exchange system and method that comprises a plurality of user accounts managed by at least one remote server. The bartering exchange system manages an inventory list of items and a wants list of items for each user account. Specifically, the bartering exchange system allows each user account to build a list of inventory items that the user account specifies to trade with any other user account and list all desired items on the wants list of items. The bartering exchange system compares the wants list of items of one arbitrary account to the inventory list for each user account to identify potential items for trade and notifies both the arbitrary account and the matching user account for the match. Thus, the arbitrary user account is able to exchange inventory items for wants items with the matching user accounts on the exchange. All items are compared and matched based on specific criteria such as item category, subcategory, geographical area, dollar values, which solves the problem of lacking common measure of values. Further, the bartering exchange system allows each user account to specify and/or modify the matching criteria.

The present invention also allows an arbitrary user account the option to create advertisements for garage sale events and relays the advertisements to each user account. The user account conducts garage sales to cash out many or all their inventory items which are also listed on the bartering exchange. After a garage sale, the leftover inventory items remain on the user account's inventory list of items in the exchange while the items sold can be moved to the user account's wants list of items for future bartering exchange with the potential matches that the bartering exchange system provides. In this way, the bartering exchange system of the present invention solves the problem of absence of a proper and convenient means of storing wealth or value or forcing each user account to use imaginary barter credits or barter dollars confined in the exchange. Thus, the present invention provides a method and system that combines all three platforms: an online platform to allow users to advertise particular goods or services that are available for bartering exchange, an online platform to allow users to advertise their upcoming communal sale including, but not limited to, garage sale, yard sale, moving sale, estate sale, community sale, multifamily sale, neighborhood sale, or etc., and an online platform to allow users to barter goods and services that are left over after the communal sale.

### SUMMARY OF THE INVENTION

An online bartering exchange system managed by at least one remote server provides a plurality of user accounts with a platform to barter exchange for desired items with inventory items. The bartering exchange method manages each user account's inventory list and wants list of items. Additionally, the method compares the wants list of items for an arbitrary user account with the inventory list of items for each of the plurality of user accounts for potential matches for bartering exchange. Further the method notifies the arbitrary account and the matching user account for the match and manages the terms-and-conditions process for the bartering exchange. The arbitrary user account and the matching user account then can complete the exchange by a face-to-face meeting or mailing/shipping using a common carrier. Additionally, the method manages the negotiation process for the arbitrary account and the matching user account if needed. The bartering exchange method manages the post-exchange feedback/review and/or ratings for each user account. Further, the method provides each user account an online process to create communal sale advertisements to sell and cash out the user's inventory items. The method allows the user to move sold inventory items to wants list of items for further bartering exchange so that more similar or same items may be sold at the next communal sale thus increasing sales.

### BRIEF DESCRIPTION OF THE DRAWINGS

FIG. 1 is a block diagram illustrating the system overview of the present invention.

FIG. 2 is a flowchart illustrating the overall process followed by the method of the present invention.

FIG. 3 is a flowchart illustrating a sub-process for prompting an arbitrary user account to generate at least one communal sale advertisement through the corresponding personal computing (PC) device and relaying the at least one communal sale advertisement to the corresponding PC device of each user accounts.

FIG. 4 is a flowchart illustrating a sub-process for the arbitrary account to update the inventory list of items with the corresponding PC device.

FIG. 5 is a flowchart illustrating a sub-process for prompting the arbitrary account to update the inventory list of items with the corresponding PC device by moving sold items in the inventory list to the wants list.

FIG. 6 is a flowchart illustrating a sub-process for identifying the potential item trade with the remote server by matching a plurality of desired characteristics of wants items with a plurality of given characteristics of inventory items.

FIG. 7 is a flowchart illustrating a sub-process for providing the arbitrary account to adjust the characteristic wants list of items and inventory list of items.

FIG. 8 is a flowchart illustrating a sub-process for identifying the potential item trade by matching both the primary identifier and secondary identifier of an entry on the wants list of items for the arbitrary account categorically with an entry on the inventory list of items for the matching account.

FIG. 9 is a flowchart illustrating a sub-process for identifying the potential item trade by matching the estimated price range of an entry on the wants list of items for the arbitrary account monetarily with the estimated price range of an entry on the inventory list of items for the matching account.

FIG. 10 is a flowchart illustrating a sub-process for identifying a new potential item trade when either of the arbitrary account or matching account declines the initial item offered for trade.

FIG. 11 is a flowchart illustrating a sub-process for providing the matching account to make a counteroffer for the potential item trade if the arbitrary account declines the potential item trade.

FIG. 12 is a flowchart illustrating a sub-process for providing the arbitrary account to make a counteroffer for the potential item trade if the matching account declines the potential item trade.

FIG. 13 is a flowchart illustrating a sub-process for providing a plurality of exchange methods for the terms-and-conditions process for the bartering exchange.

FIG. 14 is a flowchart illustrating a sub-process for providing a face-to-face exchange method for the terms-and-conditions process for the bartering exchange.

FIG. 15 is a flowchart illustrating a sub-process for providing a mail exchange method for the terms-and-conditions process for the bartering exchange.

FIG. 16 is a flowchart illustrating a sub-process for providing a set of reviews for each user account managed by the remote for the bartering exchange.

FIG. 17 is a flowchart illustrating a sub-process for prompting the arbitrary account to enter a new review for the matching account with the corresponding PC device.

FIG. 18 is a flowchart illustrating a sub-process for providing the matching account to enter a new review for the arbitrary account with the corresponding PC device.

FIG. 19 is a flowchart illustrating a sub-process for providing a set of ratings for each user account managed by the remote server.

FIG. 20 is a flowchart illustrating a sub-process for providing the arbitrary account to enter a new rating for the matching account with the corresponding PC device.

FIG. 21 is a flowchart illustrating a sub-process for providing the matching account to enter a new rating for the arbitrary account with the corresponding PC device.

FIG. 22 is a flowchart illustrating a sub-process for providing a statistical summary report of ratings for a desired user account to the corresponding PC device.

### DETAIL DESCRIPTIONS OF THE INVENTION

All illustrations of the drawings are for the purpose of describing selected versions of the present invention and are not intended to limit the scope of the present invention.

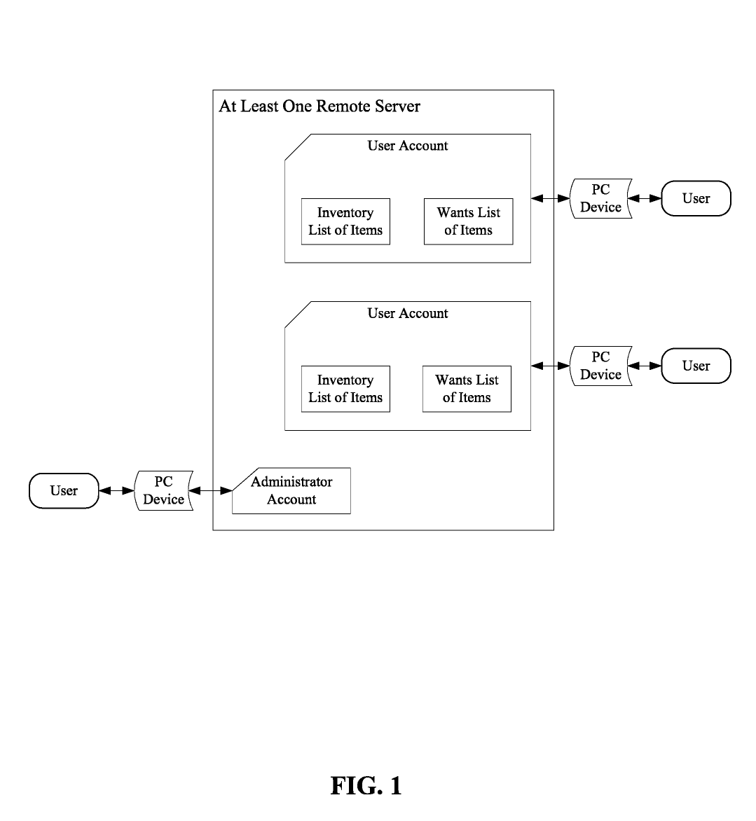

As can be seen in FIG. 1 through FIG. 22, the preferred embodiment of the present invention is a system and method for performing online bartering exchange among a plurality of user accounts. The method of the present invention manages an inventory list of items and a wants list of items for each of the plurality of user accounts. The inventory list of items, may include, but is not limited to: (1) items that the user is advertising that is available for purchase or bartering exchange at the user's upcoming communal sale including, but not limited to garage sale, yard sale, moving sale, estate sale, community sale, multifamily sale, neighborhood sale, or etc.; (2) items that the user has left over after a communal sale; and/or (3) items that the user simply does not want anymore. Specifically, the method prompts each user account to build a list of inventory items to trade with any other user account. Additionally, the method prompts the user account to list all desired items on the wants list of items. The method compares the wants list of items of one arbitrary account to the inventory list of items of each user account to identify potential items for trade. Once a match is identified, the method notifies both the arbitrary account and the matching user account for the match. Thus, the arbitrary user account is able to offer at least one item on the inventory list of items to exchange for the wants item of the arbitrary account with the matching user account. All items are compared and matched using specific criteria based on the specific characteristics for each entry within the inventory list and wants list of items including, but not limited to, item category, subcategory, geographical area, price range, dollar values, etc. Further, the method allows each user account to specify and/or modify the matching criteria and characteristics of each entry within the inventory list and wants list of items.

The method of the present invention provides the arbitrary account the option to create advertisements for communal sales and relays the advertisements to each user account. The user conducts communal sales to cash out many or all inventory items which are also listed on the online bartering exchange. After the communal sale, the leftover inventory items remain on the arbitrary account's inventory list of items while the items sold can be moved to the arbitrary account's wants list of items for future bartering exchanges with the potential matches the bartering exchange system provides. In this way, the method of the present invention offers an efficient and convenient means of storing wealth or value without forcing each user account to use imaginary barter credits or barter dollars confined in the bartering exchange.

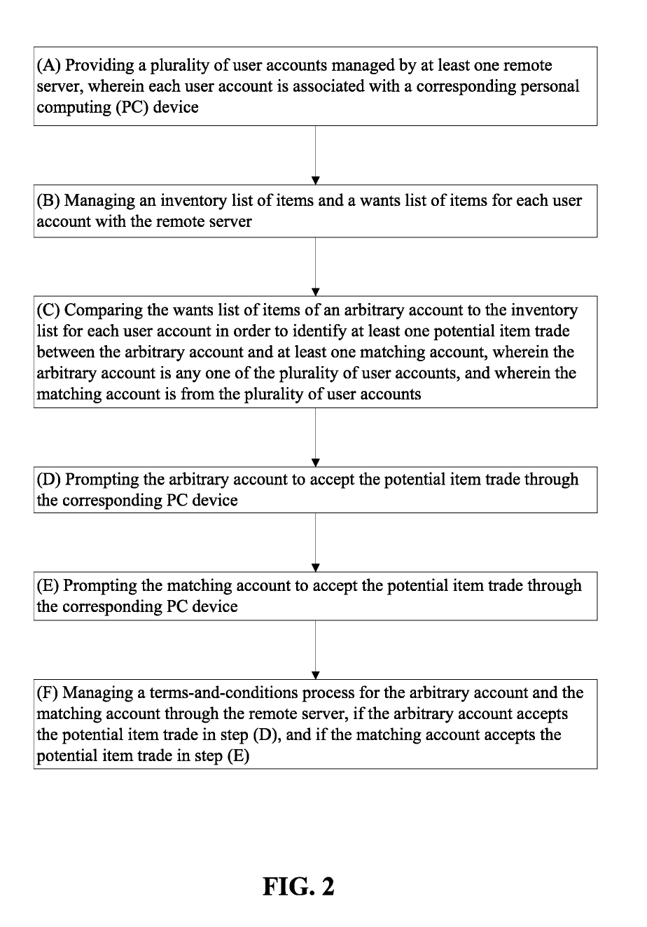

As can be seen in FIG. 1, the method of the present invention provides an online barter exchange platform between multiple users. To accomplish this, the method of the present invention associates each of the plurality of users with a unique user account from a plurality of user accounts that is managed by at least one remote server (Step A) as seen in FIG. 2. Each of the plurality of user accounts is associated with a corresponding user personal computing (PC) device. The corresponding user PC device allows a user to interact with the present invention and can be, but is not limited to, a smartphone, a smart watch, a laptop, a desktop, or a tablet PC. The users of the user accounts may include relevant parties such as, but are not limited to, individuals, consumers, corporations, brokers, advertisers and administrators. Further, the at least one remote server is used to manage the online bartering exchange between the plurality of user accounts. The remote server can be managed through an administrator account by an administrator as seen in FIG. 1. Moreover, the remote server is used to execute a number of internal software processes and store data for the present invention. The software processes may include, but are not limited to, server software programs, web-based software applications or browsers embodied as, for example, but not be limited to, websites, web applications, desktop applications, and mobile applications compatible with a corresponding user PC device. Additionally, the software processes may store data into internal databases and communicate with external databases, which may include but are not limited to map databases (such as Google Maps®), value/price comparison databases, databases maintaining data about sales of automobiles (such as Kelley Blue Book®), databases maintaining data about sales of books (such as BookFinder®), etc. The interaction with external databases over a communication network may include, but is not limited to, the Internet.

As can be seen in FIG. 2, the method used to execute the bartering exchange of the present invention manages an inventory list of items and a wants list of items for each user account with the remote server (Step B). The inventory list of items, may include, but is not limited to: (1) items that the user is advertising that is available for purchase or bartering exchange at the user's upcoming communal sale including, but not limited to garage sale, yard sale, moving sale, estate sale, community sale, multifamily sale, neighborhood sale, or etc.; (2) items that the user has left over after a communal sale; and/or (3) items that the user simply does not want anymore. More specifically, the inventory list of items comprises a plurality of items that a user account has and intends to sell at the upcoming communal sale or trade away, in exchange for cash at the upcoming communal sale or for the items on the wants list of items, which comprises the desired items the user account is seeking. The method of the present invention provides sufficient flexibility to each user account to update the inventory list of items and wants list of items. Once at least one item is specified on each of the wants list of items and inventory list of items, the method compares the wants list of items of an arbitrary user account to the inventory list of items for each user account in order to identify at least one potential item trade between the arbitrary account and at least one matching account (Step C). Specifically, the arbitrary account is any one of the plurality of user accounts, and the matching account is from the plurality of user accounts. Additionally, the potential item trade comprises an item of the inventory list of items from a matching account that matches the specific item of the arbitrary account's wants list of items, and an item of the inventory list of items from the arbitrary account that matches the matching account's wants list of items. Further, the potential item trade is identified based on various matching criteria including, but not limited to, system default criteria, user-input criteria, and/or user-modified system criteria. These matching criteria can comprise a variety of characteristics associated with each entry of the items, provided and managed by the bartering exchange system, which include, but are not limited to, category and subcategory, geographical location, age, service life, condition, estimated value/price, etc.

When a match is identified through the remote server, the method of the present invention prompts the arbitrary account to accept the potential item trade through the corresponding PC device (Step D) and prompts the matching account to accept the potential item trade through the corresponding PC device (Step E) as seen in FIG. 2. Specifically, the method sends out a notification to the arbitrary account regarding the specific wants list item that is matched with the inventory list item of the matching account. The arbitrary account is also notified about the inventory item that is desired by the matching account. At the same time, a similar notification is sent to the matching account for potential trade with the specific item on the inventory list of items of the matching account and the arbitrary account's inventory item in return. The notifications may be sent through emails, text messages, and any other suitable communication methods. Additionally, the method provides each of the plurality of user accounts with the ability to turn off the notification when a match is identified for a potential item trade. In this case, the method will leave the notification of the potential item trade to the user account on the remote server for access by the user whenever desired.

Next, the method of the present invention manages a terms-and-conditions process for the arbitrary account and the matching account through the remote server (Step F), if the arbitrary account accepts the potential item trade in Step D, and if the matching account accepts the item offered for trade in Step E. The terms-and-conditions process managed by the remote server provides the arbitrary account and the matching account to reach an agreement for the bartering exchange, which may include, but is not limited to, face-to-face or “Meet and Greet” bartering exchange in a public venue, or mail/shipping details such as addresses, when to ship, speed of shipping, shipping carrier, etc.

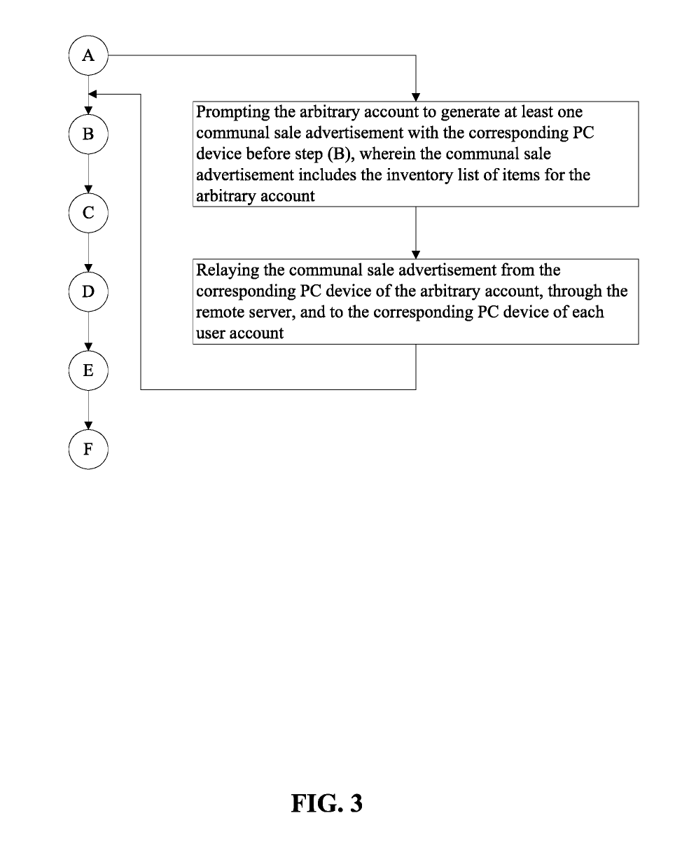

As can be seen in FIG. 3, in an embodiment of the present invention, the bartering exchange method provides an effective and convenient sub-process for the user to decrease inventory and cash out the barter items through physical communal sales. The embodiment of the online bartering exchange system prompts the arbitrary account to generate at least one communal sale advertisement with the corresponding PC device before Step B, wherein the communal sale advertisement includes the inventory list of items for the arbitrary account. Additionally, the method relays the communal sale advertisement from the corresponding PC device of the arbitrary account, through the remote server, and to the corresponding PC device of each user account. In the at least one advertisement for one or more upcoming communal sale, detailed information including, but not limited to, time, address, and items for sale, is relayed to each user account. Additionally, the at least one communal sale advertisement includes detailed information for each item such as description, category, subcategory, age, service life, condition, geographical location, photos, etc. The user associated with each user account has an opportunity to visit a communal sale of the arbitrary account to acquire desired items with a cash purchase or wait until the communal sale is over to barter for the leftover inventory items. After the exchange of items, the user may retain the item, sell the item at another communal sale in the future, or list the item as inventory which can be used for future bartering exchange or communal sales.

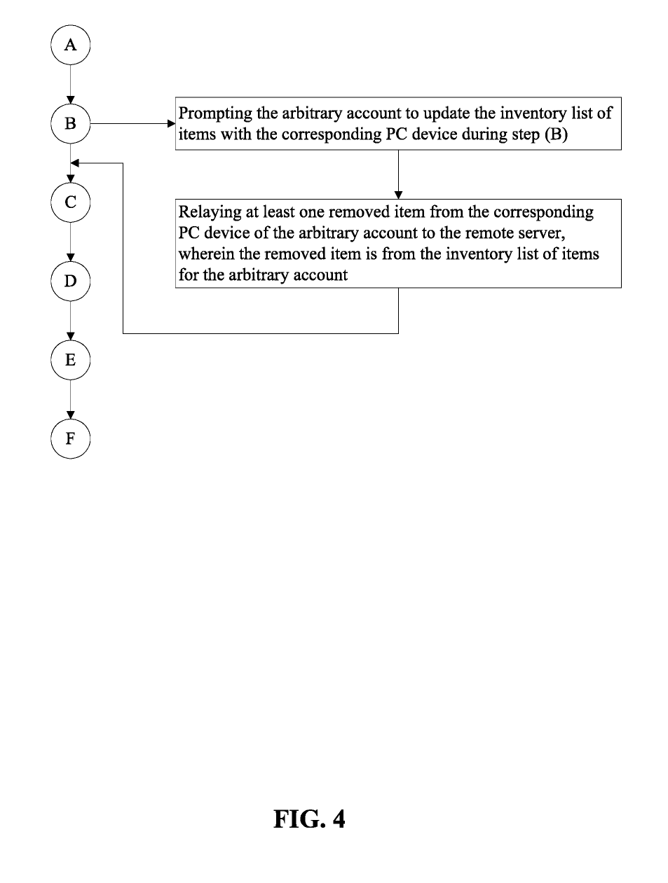

As can be seen in FIG. 4, in another embodiment of the present invention, the bartering exchange method provides the arbitrary account with a sub-process to make changes to the inventory list and wants list of items after physical communal sales. Specifically, the method prompts the arbitrary account to update the inventory list of items with the corresponding PC device in Step B. The update may include, but not limited to, removing one or more sold item from the inventory list for the arbitrary account after the communal sale. Additionally, the method relays at least one removed item from the corresponding PC device of the arbitrary account to the remote server, wherein the removed item is from the inventory list of items for the arbitrary account.

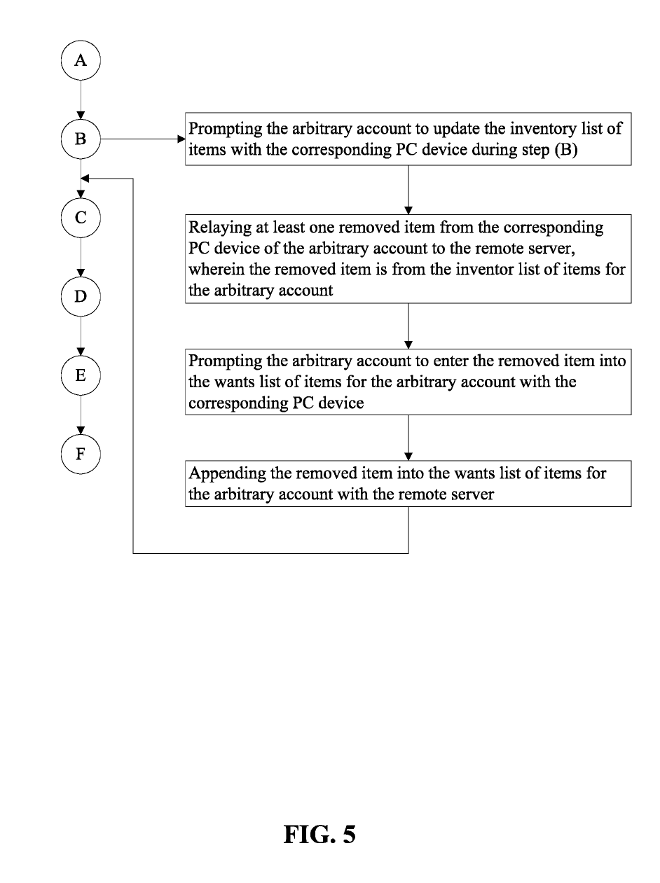

In yet another embodiment of the present invention, the method prompts the arbitrary account to enter the removed item into the wants list of items for the arbitrary account with the corresponding PC device and appends the removed item into the wants list of items for the arbitrary account with the remote server, as seen in FIG. 5. Specifically, after the one or more communal sale, the method provides the arbitrary account a means to remove any inventory items sold during the communal sale or move the sold items from the inventory list of items to wants list of items. Further, the user for the arbitrary account can add new items to the wants list of items based on the customer feedback during the communal sale to increase the volume of sales for the future communal sales.

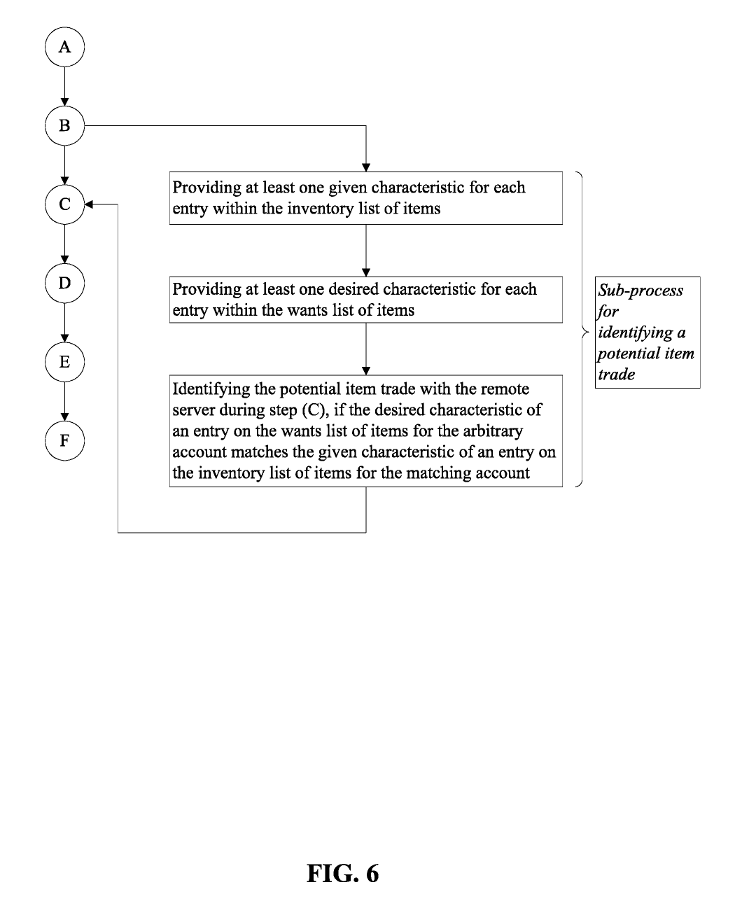

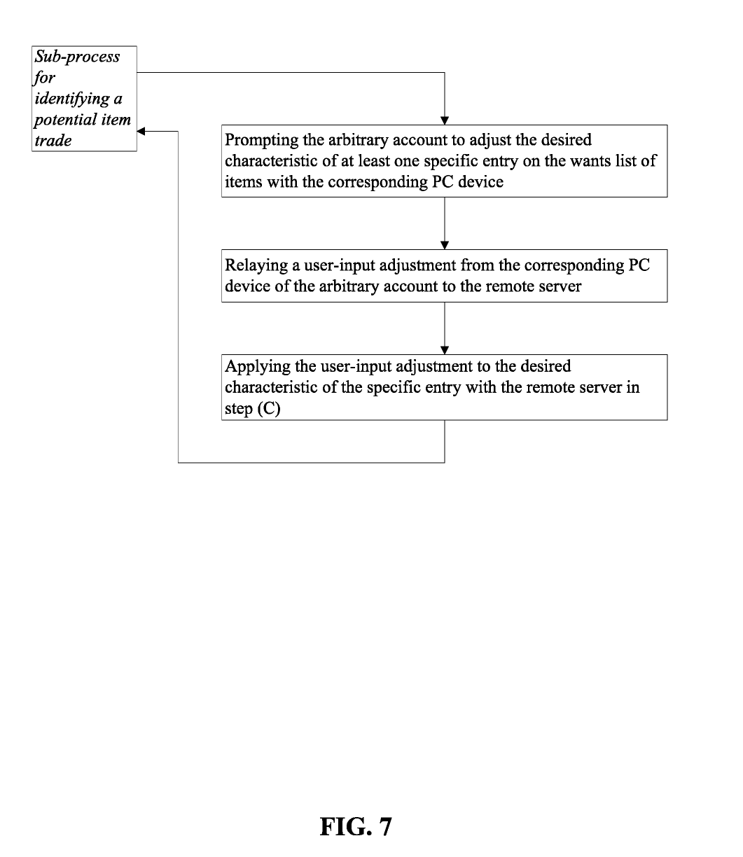

As can be seen in FIG. 6, in yet another embodiment of the present invention, the bartering exchange method provides at least one given characteristic for each entry within the inventory list of items and at least one desired characteristic for each entry within the wants list of items. Subsequently, the method identifies the potential item trade with the remote server during Step C, if the desired characteristic of an entry within the wants list of items for the arbitrary account matches the given characteristic of an entry within the inventory list of items for the matching account. More specifically, the set of characteristics associated with each entry may include, but is not limited to, category and subcategory, geographical location, age, service life, condition, estimated value/price, etc. For example, a used swivel office chair (or desk chair) within the inventory list of items of the arbitrary account may have a set of characteristics including category of furniture, subcategory of chair, location of Long Island, N.Y., seven years of age, six years in service, fair condition (with photos), estimated value/price of $50, etc. Further, the method prompts the arbitrary account to adjust the desired characteristic of at least one specific entry on the wants list of items with the corresponding PC device, relays a user-input adjustment from the corresponding PC device of the arbitrary account to the remote server, and applies the user-input adjustment to the desired characteristic of the specific entry with the remote server in Step C, as seen in FIG. 7. For example, the method may conduct search for a match within a specific geographic region, which may be a radius of 50 miles around the location of the arbitrary account (Step C). Any wants list of items for the arbitrary account may be matched with the inventory list of items for all user accounts within the 50-mile radius region. Additionally, the method prompts the arbitrary account to specify a different geographic region including, but not limited to, a 25-mile radius or any other radius around the arbitrary account, or a city, a county, a state, and/or a country.

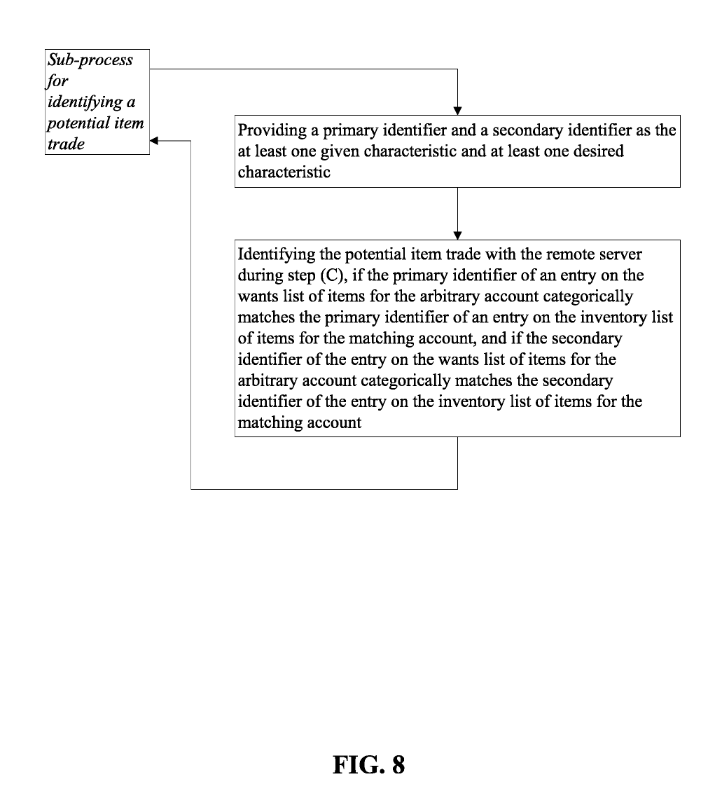

In some embodiments, the method of the present invention provides a primary identifier and a secondary identifier as the at least one given characteristic and at least one desired characteristic, as seen in FIG. 8. Subsequently, the method identifies the potential item trade with the remote server during Step C, if the primary identifier of an entry within the wants list of items for the arbitrary account categorically matches the primary identifier of an entry within the inventory list of items for the matching account, and if the secondary identifier of the entry within the wants list of items for the arbitrary account categorically matches the secondary identifier of the entry within the inventory list of items for the matching account. For example, the method may search and compare an item of the wants list of items of the arbitrary account with the inventory list of items of all other user accounts based on the item's primary identifier—category of furniture and the item's secondary identifier—subcategory of chair.

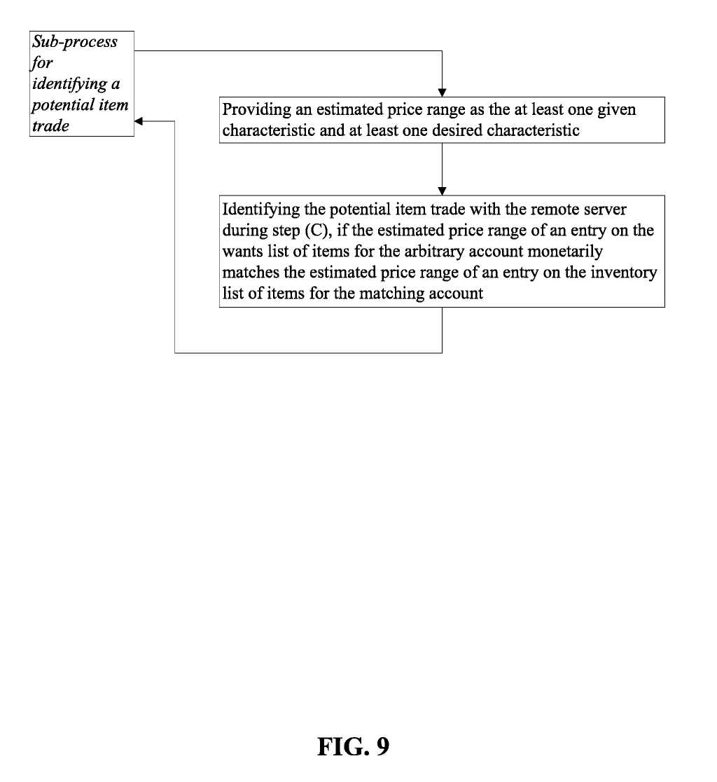

In another embodiment, the method of the present invention may provide an estimated price range as the at least one given characteristic and at least one desired characteristic, and identifies the potential item trade with the remote server during Step C, if the estimated price range of an entry on the wants list of items for the arbitrary account monetarily matches the estimated price range of an entry on the inventory list of items for the matching account, as seen in FIG. 9. More specifically, the method may conduct searches and matches by comparing estimated values of various items. The method may collect suitable data, such as the suggested values of similar items listed on linked external databases, and estimated values of various items listed on the internal databases of the bartering exchange system.

In some embodiments, the method of the present invention may provide an estimated value of an item as the at least one given characteristic and at least one desired characteristic, and identifies the potential item trade with the remote server during Step C. More specifically, the method estimates the values of different items based on description of the items, past selling prices of similar items, values of similar items obtained from the external databases, and any other related characteristic. For example, the value of electronic items like a cellphone, or a computer, may be estimated by analyzing the age of the item, the number of years the item has been used, the current condition, and the current value of the item if the item were to be purchased from the market. Further, the method may perform image analysis on the images of the item to determine the current condition of the item for the price/value estimation.

In an exemplary embodiment, the value of an automobile may be determined by analyzing the age, the present condition, and the number of miles that have been driven on the automobile. The method of the present invention may analyze data for similar vehicles obtained from other external databases, such as Kelley Blue Book®, and estimates the value of the automobile.

In another exemplary embodiment, the method of the present invention may estimate the value of the items based on the values of similar items sold by the same manufacturer. However, for example, if a furniture item is locally made by a small company or an individual, the method may determine the value by analyzing the original purchase receipt of the product, the age of the item and the current condition of the item.

In yet another exemplary embodiment, the method may estimate the value by analyzing the popularity of an item, such as a book. The method may obtain information about the popularity of the book from an external database such as Amazon®. In another exemplary embodiment, the method may estimate the value of artwork items. The method may do so by creating a database of known artists and their works and may take into account the prior sales of the artists, and artworks, and therefore estimates the value of the artwork under consideration.

In some embodiments, the method may relay the estimated values to each of the plurality of user accounts. Thus, when a notification from the remote server for the potential item trade is received, both the arbitrary account and matching account can view the estimated value or price range of the item in order to make a decision to accept or decline the trade, or to counteroffer one or more items based on the estimated value of the offered item.

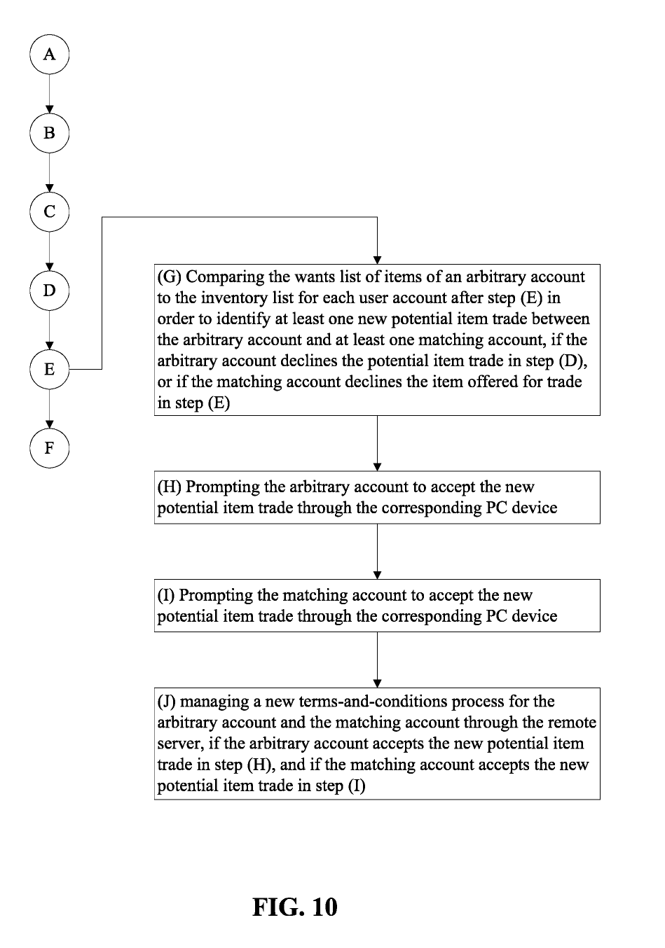

As can be seen in FIG. 10, in yet another embodiment of the present invention, the bartering exchange method offers a sub-process for conducting a new search to identify at least one new potential item trade for the arbitrary account when the original match made by the bartering exchange system was declined by either the arbitrary account or the matching account. More specifically, the method compares the wants list of items of an arbitrary account to the inventory list for each user account after Step E in order to identify at least one new potential item trade between the arbitrary account and at least one matching account (Step G), if the arbitrary account declines the potential item trade in Step D, or if the matching account declines the item offered for trade in Step E. Next, the method prompts the arbitrary account to accept the new potential item trade through the corresponding PC device (Step H) and prompts the matching account to accept the new potential item trade through the corresponding PC device (Step I). This sub-process may continue until a potential trade identified by the bartering exchange system is accepted by both the arbitrary account and the matching account. Subsequently, the method manages a new terms-and-conditions process for the arbitrary account and the matching account through the remote server (Step J), if the arbitrary account accepts the new potential item trade in Step H, and if the matching account accepts the new potential item trade in Step I.

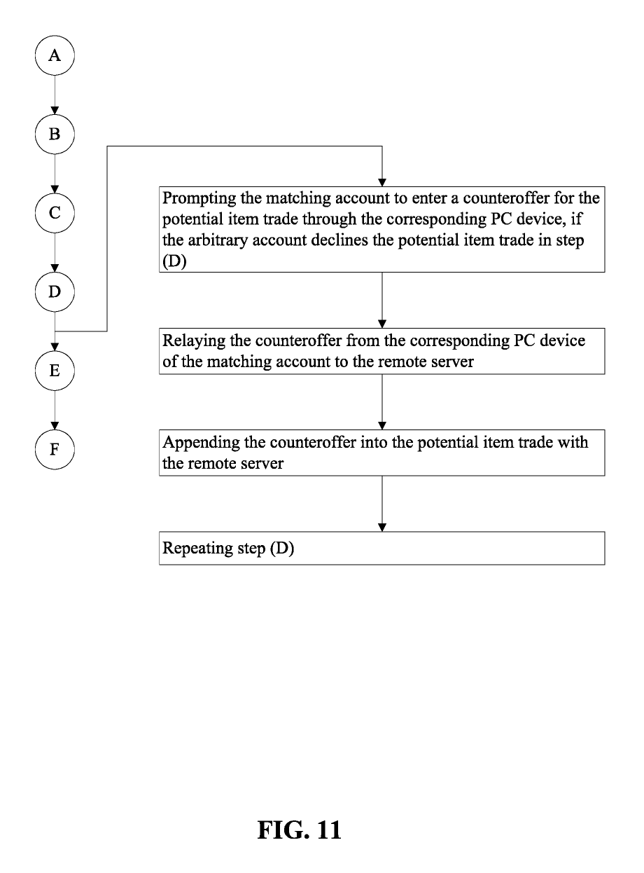

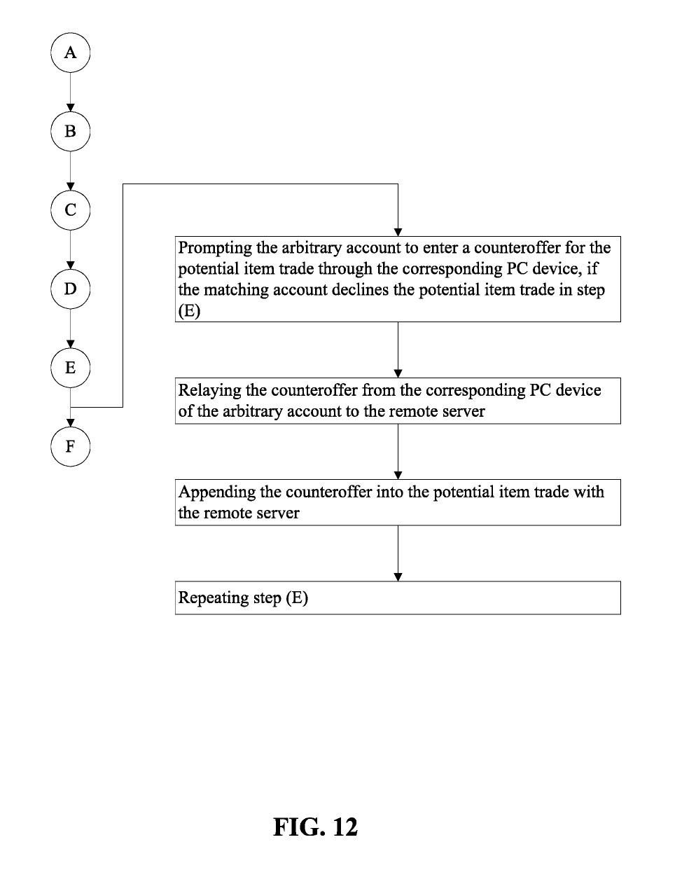

In other embodiments of the present invention, the method comprises a sub-process of negotiating a deal between the arbitrary account and the matching account. In this case, the original match made by the bartering exchange system is neither accepted nor declined. More specifically, the negotiation process begins when either the matching account or the arbitrary account makes a counteroffer based on the potential item trade identified by the remote server and no party involved declined the potential item trade. In one embodiment of the present invention, the method prompts the matching account to enter a counteroffer for the potential item trade through the corresponding PC device, if the arbitrary account declines the potential item trade in Step D and relays the counteroffer from the corresponding PC device of the matching account to the remote server. Subsequently, the method appends the counteroffer into the potential item trade with the remote server and repeats Step D, as seen in FIG. 11. This negotiation process may continue until both parties accept the each other's counteroffer, or either party declines the counteroffer from the other party. Further, as can be seen in FIG. 12, the method may prompt the arbitrary account to enter a counteroffer for the potential item trade through the corresponding PC device, if the matching account declines the potential item trade in Step E and relays the counteroffer from the corresponding PC device of the arbitrary account to the remote server. Subsequently, the method appends the counteroffer into the potential item trade with the remote server and repeats Step E. Further, the method provides a means of engaging the user of the arbitrary account and user of the matching account in negotiations via messages, phone calls, or video calls managed by the remote server. For example, during the negotiations, the user associated with the arbitrary account may agree to offer one or more items in exchange for the potential item trade from the matching account. The negotiations may continue until an agreement is reached between both parties and the method leads both parties to the terms-and-conditions determination process in Step F.

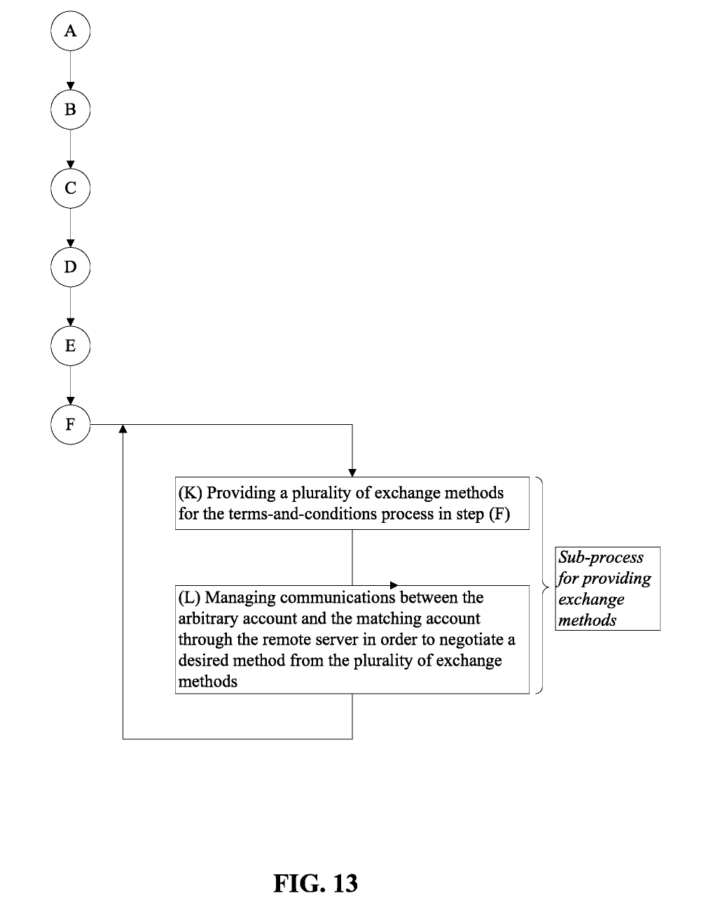

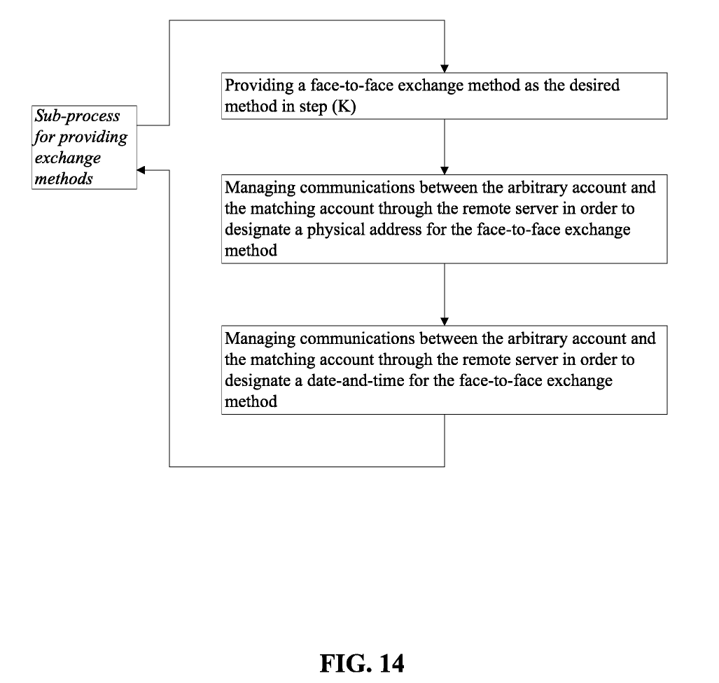

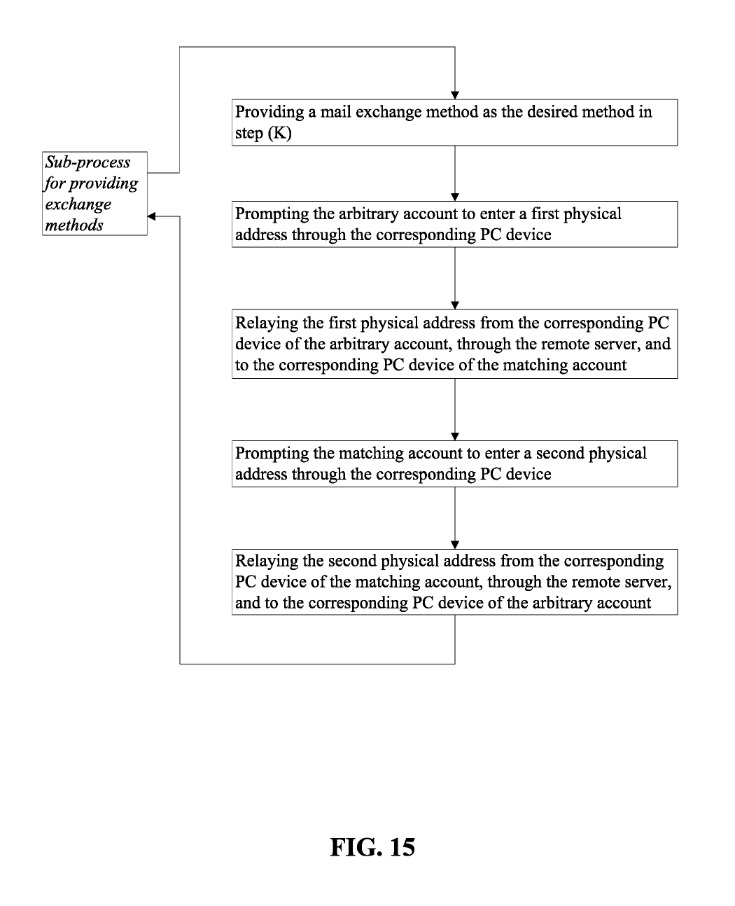

As can be seen in FIG. 13, in other embodiments of the present invention, the bartering exchange method offers a specific sub-process for the arbitrary account and matching account to exchange the items. More specifically, the method provides a plurality of exchange methods for the terms-and-conditions process in Step F (Step K). The plurality of exchange methods may include, but is not limited to, face-to-face (or Meet-and-Greet) exchange, mail (or pack-and-ship), etc. Subsequently, the method manages communications between the arbitrary account and the matching account through the remote server in order to negotiate a desired method from the plurality of exchange methods (Step L). The communications may include, but are not limited to, date and time of the exchange, venue of the exchange, mailing/shipping address, etc. Additionally, the communications may be conducted by, but not limited to, text messaging, email, teleconferencing, etc. For the exchange of the trade items, the method manages communications and monitors the process between the arbitrary account and the matching account for the bartering exchange. Specifically, the method provides a face-to-face exchange method as the desired method in Step K, and then manages communications between the arbitrary account and the matching account through the remote server in order to designate a physical address for the face-to-face exchange method, as seen in FIG. 14. Additionally, the method manages communications between the arbitrary account and the matching account through the remote server in order to designate a date-and-time for the face-to-face exchange method. This sub-process is also known as “Meet and Greet” face-to-face exchange of barter items, wherein the arbitrary account and matching account each brings the item(s) to the venue at the appropriate date and time per agreement to complete the exchange. Further, the method provides a mail exchange method as the desired method in Step K, as seen in FIG. 15. More specifically, the method prompts the arbitrary account to enter a first physical address through the corresponding PC device, relays the first physical address from the corresponding PC device of the arbitrary account, through the remote server, and to the corresponding PC device of the matching account. Additionally, the method prompts the matching account to enter a second physical address through the corresponding PC device, relays the second physical address from the corresponding PC device of the matching account, through the remote server, and to the corresponding PC device of the arbitrary account. This embodiment provides a mail/ship method for the arbitrary account and the matching account to exchange the bartering items with each other. The mail/shipping of the items may comprise the predetermined details including, but not limited to, shipping carrier, shipping method such as ground, air, etc., shipping terms such as next day, two to three days, etc., return policy, warranty, etc.

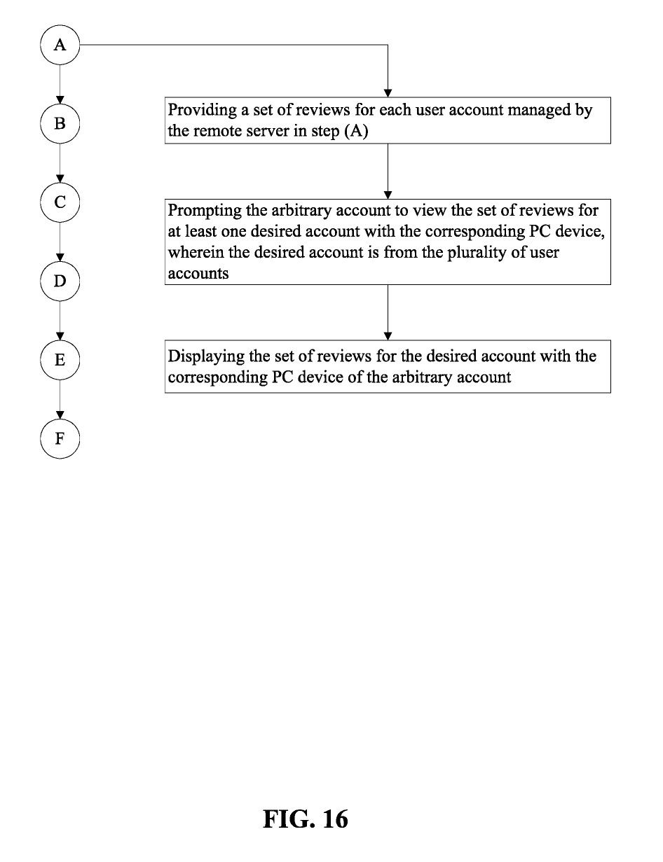

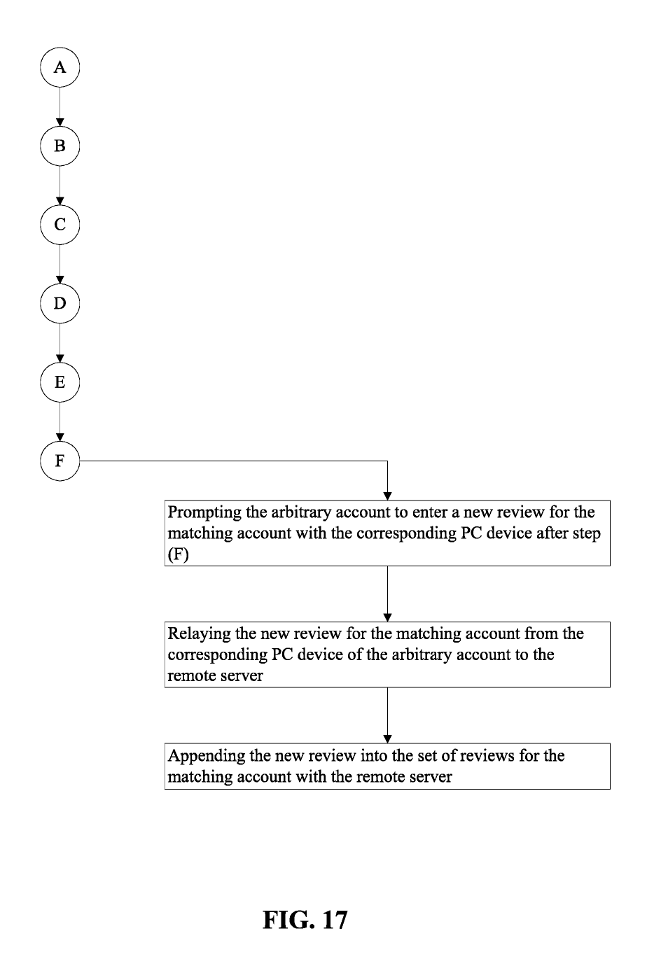

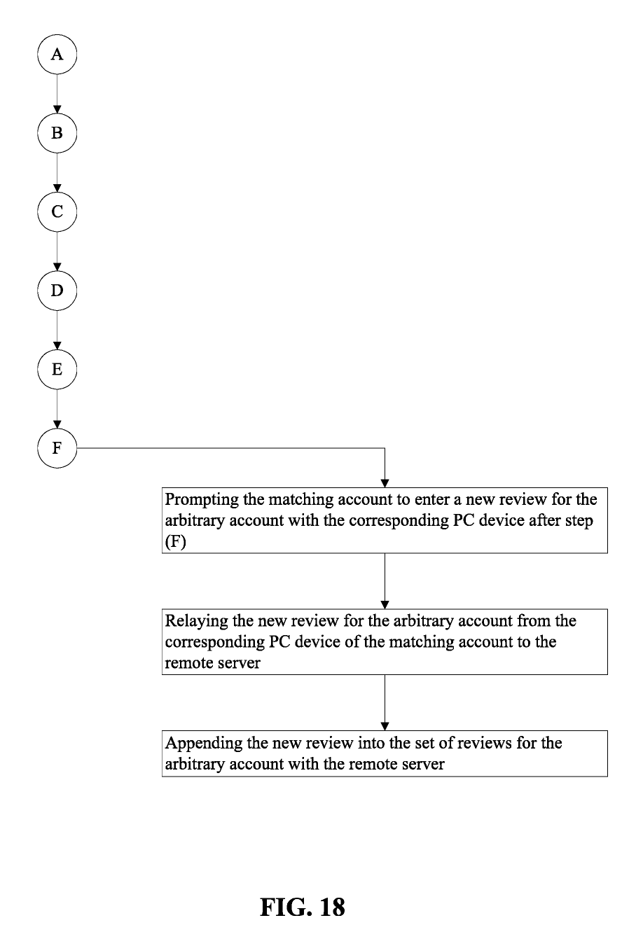

In other embodiments of the present invention, the bartering exchange method provides a feedback and review sub-process of the bartering exchange, as seen in FIG. 16. More specifically, the method provides a set of reviews for each user account managed by the remote server in Step A prompts the arbitrary account to view the set of reviews for at least one desired account with the corresponding PC device, wherein the desired account is from the plurality of user accounts. The set of reviews may include, but is not limited to, a review of the bartering exchange experience, a review of the party the user had the bartering exchange with, etc. Additionally, the method displays the set of reviews for the desired account with the corresponding PC device of the arbitrary account. Thus, any one of the plurality of user accounts may view the reviews for any other user account before and/or during a potential bartering exchange. The reviews can play an important role for decision making during the bartering process. In other embodiments of the present invention, as seen in FIGS. 17-18, the method offers a sub-process to manage the review entry by any party of a bartering exchange. Specifically, the method prompts the arbitrary account to enter a new review for the matching account with the corresponding PC device after Step F, relays the new review for the matching account from the corresponding PC device of the arbitrary account to the remote server, and appends the new review into the set of reviews for the matching account with the remote server. Additionally, the method prompts the matching account to enter a new review for the arbitrary account with the corresponding PC device after Step F, relays the new review for the arbitrary account from the corresponding PC device of the matching account to the remote server, and appends the new review into the set of reviews for the arbitrary account with the remote server. The method subsequently stores the reviews to the corresponding user account and makes them available to all user accounts.

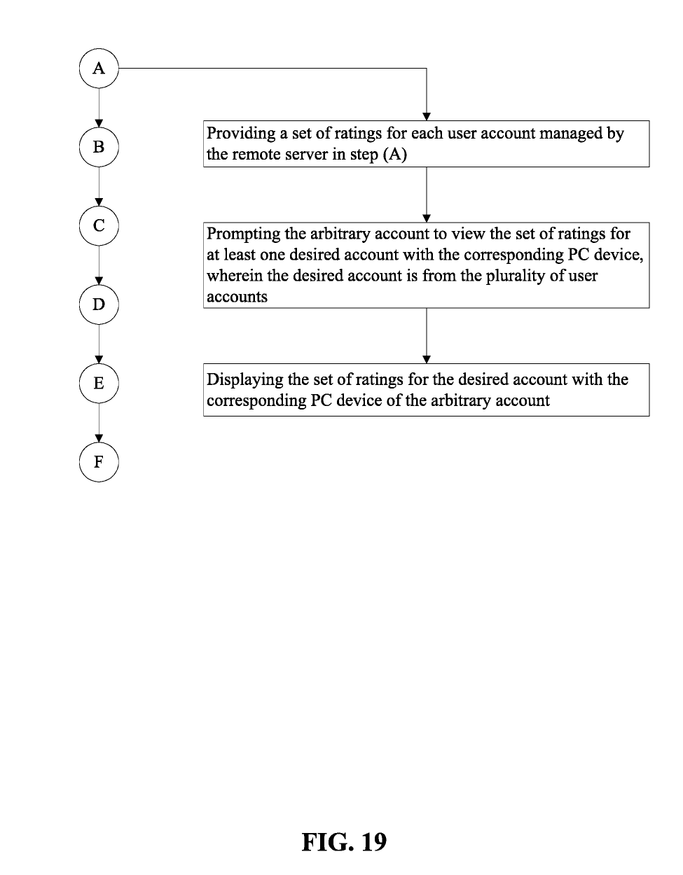

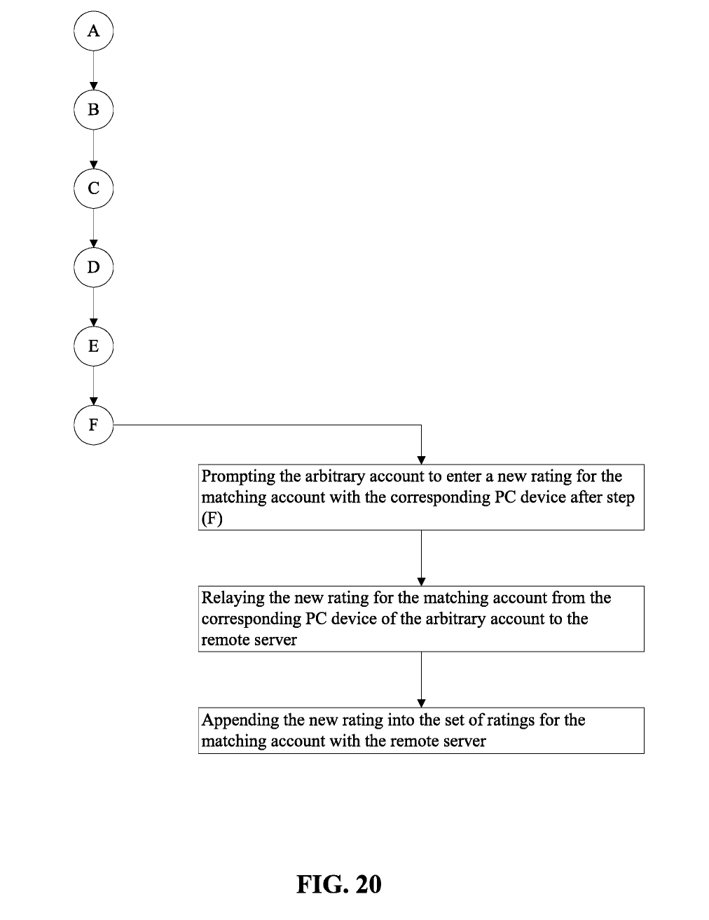

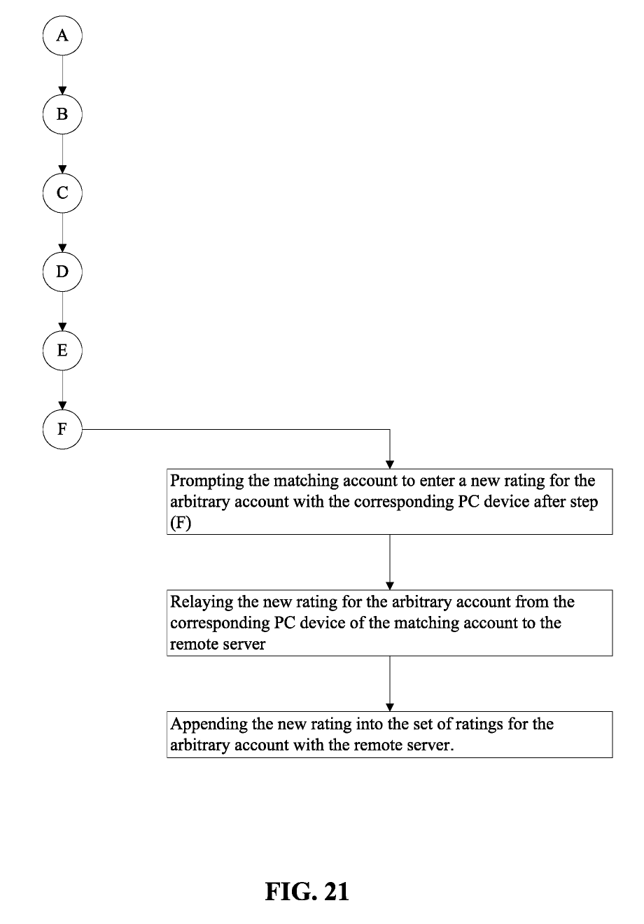

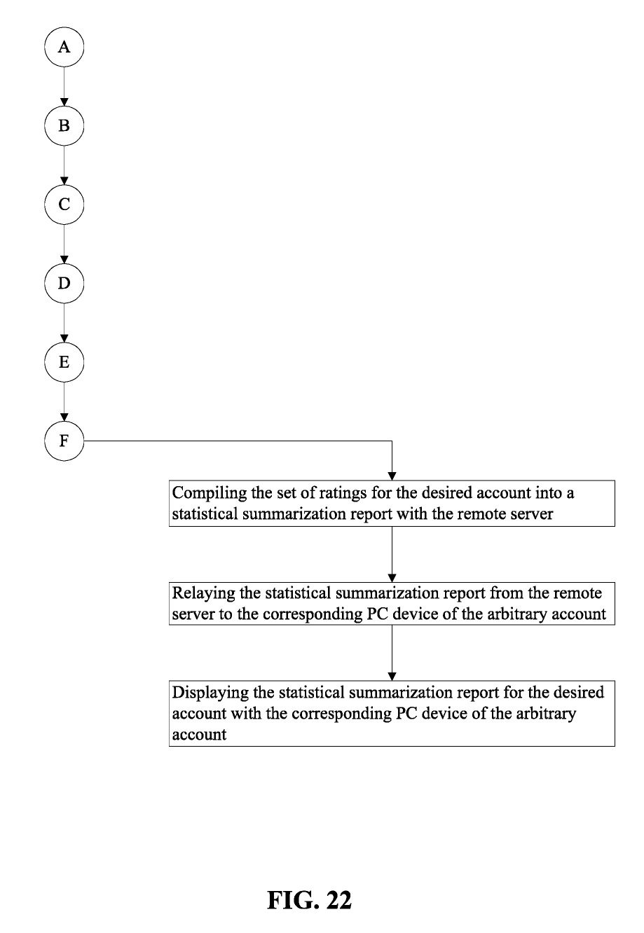

Similarly, in other embodiments of the present invention, the method provides a rating sub-process of the bartering exchange, as seen in FIG. 19. More specifically, the method provides a set of ratings for each user account managed by the remote server in Step A. The method then prompts the arbitrary account to view the set of ratings for at least one desired account with the corresponding PC device, wherein the desired account is from the plurality of user accounts. Further, the method displays the set of ratings for the desired account with the corresponding PC device of the arbitrary account. The set of ratings used for the bartering exchange can include, but is not limited to, one-to-five-star, one-to-ten satisfaction level, etc. Further, the set of ratings associated with a user account is an important piece of information for any other user account to make a decision regarding the potential bartering exchange. In other embodiments of the present invention, as seen in FIGS. 20-21, the method prompts both parties involved in a bartering exchange to create a rating for each other. More specifically, the method prompts the arbitrary account to enter a new rating for the matching account with the corresponding PC device after Step F, relays the new rating for the matching account from the corresponding PC device of the arbitrary account to the remote server, and appends the new rating into the set of ratings for the matching account with the remote server. Additionally, the method prompts the matching account to enter a new rating for the arbitrary account with the corresponding PC device after Step F, relays the new rating for the arbitrary account from the corresponding PC device of the matching account to the remote server, and appends the new rating into the set of ratings for the arbitrary account with the remote server. Further, the method, in other embodiment of the present invention, statistically processes the rating data entered by any user account to be assigned to the corresponding user account, as seen in FIG. 22. More specifically, the method compiles the set of ratings for the desired account into a statistical summarization report with the remote server, relays the statistical summarization report from the remote server to the corresponding PC device of the arbitrary account, and displays the statistical summarization report for the desired account with the corresponding PC device of the arbitrary account. The statistically summarization report may include, but is not limited to, an average rating with total number of ratings, a rating band showing the position of the specific user account on the band, or an overall star rating, etc.

Although the invention has been explained in relation to its preferred embodiment, it is to be understood that many other possible modifications and variations can be made without departing from the spirit and scope of the invention as hereinafter claimed.

What is claimed is:

1. A method for managing online bartering exchange, the method comprising the steps of:
(A) providing a plurality of user accounts managed by at least one remote server, wherein each user account is associated with a corresponding personal computing (PC) device;
(B) managing an inventory list of items and a wants list of items for each user account with the remote server;
(C) comparing the wants list of items of an arbitrary account to the inventory list for each user account in order to identify at least one potential item trade between the arbitrary account and at least one matching account, wherein the arbitrary account is any one of the plurality of user accounts, and wherein the matching account is from the plurality of user accounts;
(D) prompting the arbitrary account to accept the potential item trade through the corresponding PC device;
(E) prompting the matching account to accept the potential item trade through the corresponding PC device; and
(F) managing a terms-and-conditions process for the arbitrary account and the matching account through the remote server, if the arbitrary account accepts the potential item trade in step (D), and if the matching account accepts the potential item trade in step (E).

2. The method for managing online bartering exchange, the method as claimed in claim 1 comprising the steps of:
prompting the arbitrary account to generate at least one communal sale advertisement with the corresponding PC device before step (B), wherein the communal sale advertisement includes the inventory list of items for the arbitrary account; and
relaying the communal sale advertisement from the corresponding PC device of the arbitrary account, through the remote server, and to the corresponding PC device of each user account.

3. The method for managing online bartering exchange, the method as claimed in claim 1 comprising the steps of:
prompting the arbitrary account to update the inventory list of items with the corresponding PC device during step (B); and
relaying at least one removed item from the corresponding PC device of the arbitrary account to the remote server, wherein the removed item is from the inventory list of items for the arbitrary account.

4. The method for managing online bartering exchange, the method as claimed in claim 3 comprising the steps of:
prompting the arbitrary account to enter the removed item into the wants list of items for the arbitrary account with the corresponding PC device; and
appending the removed item into the wants list of items for the arbitrary account with the remote server.

5. The method for managing online bartering exchange, the method as claimed in claim 1 comprising the steps of:
providing at least one given characteristic for each entry within the inventory list of items;
providing at least one desired characteristic for each entry within the wants list of items; and
identifying the potential item trade with the remote server during step (C), if the desired characteristic of an entry on the wants list of items for the arbitrary account matches the given characteristic of an entry on the inventory list of items for the matching account.

6. The method for managing online bartering exchange, the method as claimed in claim 5 comprising the steps of:
prompting the arbitrary account to adjust the desired characteristic of at least one specific entry on the wants list of items with the corresponding PC device;
relaying a user-input adjustment from the corresponding PC device of the arbitrary account to the remote server; and
applying the user-input adjustment to the desired characteristic of the specific entry with the remote server in step (C).

7. The method for managing online bartering exchange, the method as claimed in claim 5 comprising the steps of:
providing a primary identifier and a secondary identifier as the at least one given characteristic and at least one desired characteristic; and
identifying the potential item trade with the remote server during step (C), if the primary identifier of an entry on the wants list of items for the arbitrary account categorically matches the primary identifier of an entry on the inventory list of items for the matching account, and if the secondary identifier of the entry on the wants list of items for the arbitrary account categorically matches the secondary identifier of the entry on the inventory list of items for the matching account.

8. The method for managing online bartering exchange, the method as claimed in claim 5 comprising the steps of:
providing an estimated price range as the at least one given characteristic and at least one desired characteristic; and
identifying the potential item trade with the remote server during step (C), if the estimated price range of an entry on the wants list of items for the arbitrary account monetarily matches the estimated price range of an entry on the inventory list of items for the matching account.

9. The method for managing online bartering exchange, the method as claimed in claim 1 comprising the steps of:
(G) comparing the wants list of items of an arbitrary account to the inventory list for each user account after step (E) in order to identify at least one new potential item trade between the arbitrary account and at least one matching account, if the arbitrary account declines the potential item trade in step (D), or if the matching account declines the item offered for trade in step (E);
(H) prompting the arbitrary account to accept the new potential item trade through the corresponding PC device;
(I) prompting the matching account to accept the new potential item trade through the corresponding PC device; and
(J) managing a new terms-and-conditions process for the arbitrary account and the matching account through the remote server, if the arbitrary account accepts the new potential item trade in step (H), and if the matching account accepts the new potential item trade in step (I).

10. The method for managing online bartering exchange, the method as claimed in claim 1 comprising the steps of:
prompting the matching account to enter a counteroffer for the potential item trade through the corresponding PC device, if the arbitrary account declines the potential item trade in step (D);
relaying the counteroffer from the corresponding PC device of the matching account to the remote server;
appending the counteroffer into the potential item trade with the remote server; and
repeating step (D).

11. The method for managing online bartering exchange, the method as claimed in claim 1 comprising the steps of:
prompting the arbitrary account to enter a counteroffer for the potential item trade through the corresponding PC device, if the matching account declines the potential item trade in step (E);
relaying the counteroffer from the corresponding PC device of the arbitrary account to the remote server;
appending the counteroffer into the potential item trade with the remote server; and
repeating step (E).

12. The method for managing online bartering exchange, the method as claimed in claim 1 comprising the steps of:
(K) providing a plurality of exchange methods for the terms-and-conditions process in step (F); and
(L) managing communications between the arbitrary account and the matching account through the remote server in order to negotiate a desired method from the plurality of exchange methods.

13. The method for managing online bartering exchange, the method as claimed in claim 12 comprising the steps of:
providing a face-to-face exchange method as the desired method in step (K);
managing communications between the arbitrary account and the matching account through the remote server in order to designate a physical address for the face-to-face exchange method; and
managing communications between the arbitrary account and the matching account through the remote server in order to designate a date-and-time for the face-to-face exchange method.

14. The method for managing online bartering exchange, the method as claimed in claim 12 comprising the steps of:
providing a mail exchange method as the desired method in step (K);
prompting the arbitrary account to enter a first physical address through the corresponding PC device;
relaying the first physical address from the corresponding PC device of the arbitrary account, through the remote server, and to the corresponding PC device of the matching account;
prompting the matching account to enter a second physical address through the corresponding PC device; and
relaying the second physical address from the corresponding PC device of the matching account, through the remote server, and to the corresponding PC device of the arbitrary account.

15. The method for managing online bartering exchange, the method as claimed in claim 1 comprising the steps of:
providing a set of reviews for each user account managed by the remote server in step (A);
prompting the arbitrary account to view the set of reviews for at least one desired account with the corresponding PC device, wherein the desired account is from the plurality of user accounts; and
displaying the set of reviews for the desired account with the corresponding PC device of the arbitrary account.

16. The method for managing online bartering exchange, the method as claimed in claim 15 comprising the steps of:
prompting the arbitrary account to enter a new review for the matching account with the corresponding PC device after step (F);
relaying the new review for the matching account from the corresponding PC device of the arbitrary account to the remote server; and
appending the new review into the set of reviews for the matching account with the remote server.

17. The method for managing online bartering exchange, the method as claimed in claim 15 comprising the steps of:
prompting the matching account to enter a new review for the arbitrary account with the corresponding PC device after step (F);
relaying the new review for the arbitrary account from the corresponding PC device of the matching account to the remote server; and
appending the new review into the set of reviews for the arbitrary account with the remote server.

18. The method for managing online bartering exchange, the method as claimed in claim 1 comprising the steps of:
providing a set of ratings for each user account managed by the remote server in step (A);
prompting the arbitrary account to view the set of ratings for at least one desired account with the corresponding PC device, wherein the desired account is from the plurality of user accounts; and
displaying the set of ratings for the desired account with the corresponding PC device of the arbitrary account.

19. The method for managing online bartering exchange, the method as claimed in claim 18 comprising the steps of:
prompting the arbitrary account to enter a new rating for the matching account with the corresponding PC device after step (F);
relaying the new rating for the matching account from the corresponding PC device of the arbitrary account to the remote server; and
appending the new rating into the set of ratings for the matching account with the remote server.

20. The method for managing online bartering exchange, the method as claimed in claim 18 comprising the steps of:
prompting the matching account to enter a new rating for the arbitrary account with the corresponding PC device after step (F);
relaying the new rating for the arbitrary account from the corresponding PC device of the matching account to the remote server; and
appending the new rating into the set of ratings for the arbitrary account with the remote server.

21. The method for managing online bartering exchange, the method as claimed in claim 18 comprising the steps of:
compiling the set of ratings for the desired account into a statistical summarization report with the remote server;
relaying the statistical summarization report from the remote server to the corresponding PC device of the arbitrary account; and
displaying the statistical summarization report for the desired account with the corresponding PC device of the arbitrary account.
